(19) United States
(12) Patent Application Publication
(10) Pub. No.: US 2014/0086327 A1
(43) Pub. Date: Mar. 27, 2014

(54) METHOD AND TECHNIQAL EQUIPMENT FOR SCALABLE VIDEO CODING

(71) Applicant: Nokia Corporation, Espoo (FI)

(72) Inventors: Kemal Ugur, Istanbul (TR); Mehmet Oguz Bici, Tampere (FI); Miska Matias Hannuksela, Tampere (FI)

(73) Assignee: Nokia Corporation, Espoo (FI)

(21) Appl. No.: 14/034,645

(22) Filed: Sep. 24, 2013

Related U.S. Application Data
(60) Provisional application No. 61/706,727, filed on Sep. 27, 2012.

(51) Int. Cl. H04N 7/26; H04N 7/36

(52) U.S. Cl. CPC H04N 19/00424; H04N 19/00684
USPC 375/240.16

(57) ABSTRACT

The invention relates to video coding, in particular to scalable video encoding/decoding. A method according to an embodiment comprises encoding motion information of an enhancement layer using motion vector information of a base layer, wherein the encoding comprises deriving the reference index of motion vector of the enhancement layer by using a mapping process depending on the used reference picture list of the base layer and the reference index of motion vector of the base layer, and determining corresponding pictures of the enhancement layer and the base layer by mapping the respective reference picture indexes to corresponding picture order values. The embodiments relate to decoding also.

### TECHNICAL FIELD

The present application relates generally to video coding, and in particular to scalable video coding.

### BACKGROUND

Video coding comprises encoding and decoding processes. The encoding process comprises transforming an input video into a compressed representation that is suited for storage and/or transmission. The decoding process performs uncompressing the compressed representation into a viewable form.

In scalable video coding the coding structure is such where one bitstream can contain multiple representations of the content at different bitrates, resolutions or frame rates. Therefore, the received can extract the desired representation depending on its characteristics (e.g. resolution that matches best the display device). Alternatively, a server or a network element can extract the portions of the bitstream to be transmitted to the receiver depending on e.g. the network characteristics or processing capabilities of the receiver. A scalable bitstream may comprise a “base layer” that provides the lowest quality video and one or more “enhancement layers” that enhance the video quality when received and decoded together with the lower layers. The coded representation of an enhancement layer may depend on the lower layers. For example, motion information and mode information of the enhancement layer can be predicted from lower layers. Similarly, the pixel data of the lower layers can be used to create prediction for the enhancement layer.

In coders, the motion field (i.e. motion vectors and reference indices) can be predicted from spatially neighboring blocks or from blocks in different frames. In order to improve scalable video coding and in particular the process for predicting motion field from frames belonging to different layers, the following is proposed.

### SUMMARY

Now there has been invented an improved method and technical equipment implementing the method, by which the scalable video coding can be improved. Various aspects of the invention include a method, an apparatus, a server, a client and a computer readable medium comprising a computer program stored therein, which are characterized by what is stated in the independent claims. Various embodiments of the invention are disclosed in the dependent claims.

According to a first aspect of the present invention, the method comprises encoding motion information of an enhancement layer using motion vector information of a reference layer; wherein the encoding comprises deriving a reference index of a motion vector of the enhancement layer by using a mapping process depending on the used reference picture list of the reference layer and the used reference picture list of the enhancement layer and a reference index of a motion vector of the reference layer.

According to a second aspect of the present invention, the method comprises encoding motion information of an enhancement layer using motion vector information of a reference layer, wherein the encoding comprises deriving a candidate list of motion vectors and their reference indexes; selecting a motion vector and a reference index for said encoding from said candidate list.

According to a third aspect of the present invention, the apparatus comprises at least one processor, memory including computer program code, the memory and the computer program code configured to, with the at least one processor, cause the apparatus to perform at least the following: encoding motion information of an enhancement layer using motion vector information of a reference layer; wherein the encoding comprises deriving the reference index of motion vector of the enhancement layer by using a mapping process depending on the used reference picture list of the reference layer and the user reference picture list of the enhancement layer and the reference index of a motion vector of the reference layer.

According to a fourth aspect of the present invention, the apparatus comprises at least one processor, memory including computer program code, the memory and the computer program code configured to, with the at least one processor, cause the apparatus to perform at least the following: encoding motion information of an enhancement layer using motion vector information of a reference layer, wherein the encoding comprises deriving a candidate list of motion vectors and their reference indexes; selecting a motion vector and a reference index for said encoding from said candidate list.

According to a fifth aspect of the present invention, the system comprises at least one processor, memory including computer program code, the memory and the computer program code configured to, with the at least one processor, cause the system to perform at least the following: encoding motion information of an enhancement layer using motion vector information of a reference layer; wherein the encoding comprises deriving a reference index of a motion vector of the enhancement layer by using a mapping process depending on the used reference picture list of the reference layer and the used reference picture list of the enhancement layer and a reference index of a motion vector of the reference layer.

According to a sixth aspect of the present invention, the apparatus comprises means for encoding motion information of an enhancement layer using motion vector information of a reference layer; wherein the encoding means comprises means for deriving a reference index of a motion vector of the enhancement layer by using a mapping process depending on the used reference picture list of the reference layer and the used reference picture list of the enhancement layer and a reference index of a motion vector of the reference layer.

According to a seventh aspect of the present invention, the computer program product embodied on a non-transitory computer readable medium, comprising computer program code configured to, when executed on at least one processor, cause an apparatus or a system to: encode motion information of an enhancement layer using motion vector information of a reference layer, wherein the encoding comprises deriving a reference index of a motion vector of the enhancement layer by using a mapping process depending on the used reference picture list of the reference layer and the used reference picture list of the enhancement layer and a reference index of a motion vector of the reference layer.

According to an eighth aspect of the present invention, the method for decoding video data comprises decoding motion information of an enhancement layer using motion vector information of a reference layer; wherein the decoding comprises deriving a reference index of a motion vector of the enhancement layer by using a mapping process depending on the used reference picture list of the reference layer and the used reference picture list of the enhancement layer and a reference index of a motion vector of the reference layer.

According to a ninth aspect of the present invention, the apparatus comprises at least one processor, memory including computer program code, the memory and the computer program code configured to, with the at least one processor, cause the apparatus to perform at least the following: decoding motion information of an enhancement layer using motion vector information of a reference layer; wherein the decoding comprises deriving the reference index of motion vector of the enhancement layer by using a mapping process depending on the used reference picture list of the reference layer and the user reference picture list of the enhancement layer and the reference index of a motion vector of the reference layer.

According to a tenth aspect of the present invention, the apparatus comprises means for decoding motion information of an enhancement layer using motion vector information of a reference layer; wherein the decoding means comprises means for deriving a reference index of a motion vector of the enhancement layer by using a mapping process depending on the used reference picture list of the reference layer and the used reference picture list of the enhancement layer and a reference index of a motion vector of the reference layer.

According to a eleventh aspect of the present invention, the computer program product embodied on a non-transitory computer readable medium, comprises computer program code configured to, when executed on at least one processor, cause an apparatus or a system to:

decode motion information of an enhancement layer using motion vector information of a reference layer; wherein the decoding comprises deriving a reference index of a motion vector of the enhancement layer by using a mapping process depending on the used reference picture list of the reference layer and the used reference picture list of the enhancement layer and a reference index of a motion vector of the reference layer.

According to a twelfth aspect of the present invention, the method comprises decoding motion information of an enhancement layer using motion vector information of a reference layer; wherein the decoding comprises deriving a candidate list of motion vectors and their reference indexes; selecting a motion vector and a reference index for said coding from said candidate list.

According to a thirteenth aspect of the present invention, the system comprises at least one processor, memory including computer program code, the memory and the computer program code configured to, with the at least one processor, cause the system to perform at least the following: decoding motion information of an enhancement layer using motion vector information of a reference layer, wherein the decoding comprises deriving a reference index of a motion vector of the enhancement layer by using a mapping process depending on the used reference picture list of the reference layer and the used reference picture list of the enhancement layer and a reference index of a motion vector of the reference layer.

According to an embodiment, the coding further comprises deriving a candidate list of motion vectors and their reference indexes, selecting a motion vector and a reference index for said coding from said candidate list.

According to an embodiment, the mapping process comprises utilization of a mapping table.

According to an embodiment, the mapping process comprises utilization of a mapping table.

According to an embodiment, the mapping table is initialized once per image slice.

According to an embodiment, mapping values are signalled in a bitstream to a decoder.

According to an embodiment, values for the mapping table are derived using corresponding picture order values of the reference pictures of the enhancement reference picture and the reference layer reference pictures.

According to an embodiment, the reference picture list is searched for the enhancement layer and the reference layer, the mapping table values are derived by mapping the picture order value of reference pictures in the reference layer reference picture list with the same picture order value of reference pictures in the enhancement layer reference picture list.

According to an embodiment, the searching comprises taking into account corresponding weighted prediction parameters of each reference picture in the reference picture lists of the reference layer and the enhancement layer.

According to an embodiment, a reference picture list of the enhancement layer is searched for each reference index of a reference picture list of the reference layer, such a reference index of the enhancement layer is entered to the mapping table by which the absolute difference of picture order values between the reference layer and the enhancement layer is minimum.

According to an embodiment, the method comprises searching the reference picture lists for the enhancement layer and the reference layer; for each reference picture list of the reference layer, deriving the mapping table values by mapping the picture order value of reference indexes of the reference layer reference picture list with the same picture order value of reference indexes of the respective enhancement layer reference picture list; in response to a picture order value of a first reference index of the reference layer reference picture list having no equal picture order value within the reference indexes of the respective enhancement layer reference picture list, deriving a mapping table value for the first reference index of the reference layer indicating unavailability; as response to the reference index of the motion vector of the enhancement layer having a mapping value other than indicating unavailability, including said reference index of the motion vector of the enhancement layer and a respective motion vector derived from the motion vector of the reference layer in said candidate list; as response to the reference index of the motion vector of the enhancement layer having a mapping value indicating unavailability, omitting said reference index of the motion vector of the enhancement layer and a respective motion vector derived from the motion vector of the reference layer in said candidate list.

According to an embodiment, the mapping table is initialized once per image block.

According to an embodiment, the mapping process is performed by at least one of the following rules: if corresponding picture order values of reference picture in the enhancement layer and the reference picture in the reference layer at the reference picture index of the motion vector of reference layer are identical, then reference index of the motion vector in the enhancement layer is the reference index of the motion vector in the reference layer, otherwise the reference index of the motion vector in the enhancement layer is zero; if the corresponding picture order values of a reference picture in the enhancement layer and a reference picture in the reference layer at the reference picture index of the motion vector of reference layer are identical, then reference index of the motion vector in the enhancement layer is the reference index of the motion vector in the reference layer, otherwise the reference index of the enhancement layer is such a reference index by means of which the difference between corresponding picture order values of reference pictures in enhancement layer and base layer is minimum

According to an embodiment, the picture order value is the picture order count (POC).

According to an embodiment, the reference layer is a base layer.

According to an embodiment, the reference layer is a base view.

According to an embodiment, the mapping process further comprises comparing for each reference index, the picture order value of reference pictures in enhancement layer with picture order value of reference pictures in reference layer; as response to picture order values of reference pictures in enhancement layer being equal to picture order values of reference pictures in reference layer for all reference indices, using the reference index of a motion vector of the reference layer for reference index of motion vector in enhancement layer; as response to picture order values of reference pictures in enhancement layer not being equal to picture order values of reference pictures in reference layer for all reference indices, setting the reference index of motion vector in enhancement layer to zero.

### DESCRIPTION OF THE DRAWINGS

In the following, various embodiments of the invention will be described in more detail with reference to the appended drawings, in which

FIG. 1 shows a block diagram of a video encoder according to an example from related technology;

FIG. 2 shows a block diagram of a video decoder according to an example from related technology;

FIG. 3 shows current block (or prediction unit PU) and five spatial neighbors A0, A1, B0, B1, B2 to be used as motion prediction candidates during the merge process;

FIG. 4 shows a block diagram of a filtering block illustrated in FIGS. 1 and 2;

FIG. 5 shows a block diagram of a spatial scalability encoder according to an embodiment;

FIG. 6 shows a block diagram of a decoder corresponding to the encoder shown in FIG. 4;

FIG. 7 shows a block diagram of a video coding system according to an example embodiment as a schematic block diagram of an exemplary apparatus;

FIG. 8 shows a layout of an apparatus according to an example embodiment; and

FIG. 9 shows an arrangement for video coding comprising a plurality of apparatuses, networks and network elements according to an example embodiment.

### DESCRIPTION OF EXAMPLE EMBODIMENTS

In the following, several embodiments of the invention will be described in the context of one video coding arrangement. It is to be noted, however, that the invention is not limited to this particular arrangement. In fact, the different embodiments have applications widely in any environment where improvement of scalable video coding is required. For example, the invention may be applicable to video coding/decoding systems like streaming systems, DVD players, digital televisions and set-top boxes, systems and computer programs on personal computers, handheld computers and communication devices, as well as network elements such as transcoders and cloud computing arrangements where video data is handled.

The H.264/AVC standard was developed by the Joint Video Team (JVT) of the Video Coding Experts Group (VCEG) of the Telecommunications Standardisation Sector of International Telecommunication Union (ITU-T) and the Moving Picture Experts Group (MPEG) of International Standardisation Organisation (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). There have been multiple versions of the H.264/AVC standard, each integrating new extensions or features to the specification. These extensions include Scalable Video Coding (SVC) and Multiview Video Coding (MVC).

There is a currently ongoing standardization project of High Efficiency Video Coding (HEVC) by the Joint Collaborative Team—Video Coding (JCT-VC) of VCEG and MPEG.

Some key definitions, bitstream and coding structures, and concepts of H.264/AVC and HEVC are described in this section as an example of a video encoder, decoder, encoding method, decoding method, and a bitstream structure, wherein the embodiments may be implemented. Some of the key definitions, bitstream and coding structures, and concepts of H.264/AVC are the same as in the current working draft of HEVC—hence, they are described below jointly. The aspects of the invention are not limited to H.264/AVC or HEVC, but rather the description is given for one possible basis on top of which the invention may be partly or fully realized.

Similarly to many earlier video coding standards, the bitstream syntax and semantics as well as the decoding process for error-free bitstreams are specified in H.264/AVC and HEVC. The encoding process is not specified, but encoders must generate conforming bitstreams. Bitstream and decoder conformance can be verified with the Hypothetical Reference Decoder (HRD). The standards contain coding tools that help in coping with transmission errors and losses, but the use of the tools in encoding is optional and no decoding process has been specified for erroneous bitstreams.

The elementary unit for the input to an H.264/AVC or HEVC encoder and the output of an H.264/AVC or HEVC decoder, respectively, is a picture. In H.264/AVC, a picture may either be a frame or a field. In the current working draft of HEVC, a picture is a frame. A frame comprises a matrix of luma samples and corresponding chroma samples. A field is a set of alternate sample rows of a frame and may be used as encoder input, when the source signal is interlaced. Chroma pictures may be subsampled when compared to luma pictures. For example, in the 4:2:0 sampling pattern the spatial resolution of chroma pictures is half of that of the luma picture along both coordinate axes.

During the course of HEVC standardization the terminology for example on picture partitioning units has evolved. In the next paragraphs, some non-limiting examples of HEVC terminology are provided.

In a draft HEVC standard, video pictures are divided into coding units (CU) covering the area of the picture. A CU consists of one or more prediction units (PU) defining the prediction process for the samples within the CU and one or more transform units (TU) defining the prediction error coding process for the samples in the said CU. Typically, a CU consists of a square block of samples with a size selectable from a predefined set of possible CU sizes. A CU with the maximum allowed size can be named as CTU (coding tree unit) and the video picture is divided into non-overlapping CTUs. A CTU can be further split into a combination of smaller CUs, e.g. by recursively splitting the CTU and resultant CUs. Each resulting CU typically has at least one PU and at least one TU associated with it. Each PU and TU can be further split into smaller PUs and TUs in order to increase granularity of the prediction and prediction error coding processes, respectively. Each PU has prediction information associated with it defining what kind of a prediction is to be applied for the pixels within that PU (e.g. motion vector information for inter predicted PUs and intra prediction directionality information for intra predicted PUs). Similarly each TU is associated with information describing the prediction error decoding process for the samples within the said TU (including e.g. DCT coefficient information). It is typically signalled at CU level whether prediction error coding is applied or not for each CU. In the case there is no prediction error residual associated with the CU, it can be considered there are no TUs for the said CU. The division of the image into CUs, and division of CUs into PUs and TUs is typically signalled in the bitstream allowing the decoder to reproduce the intended structure of these units.

A Network Abstraction Layer (NAL) unit is a unit for the output of an H.264/AVC or HEVC encoder and the input of an H.264/AVC or HEVC decoder. For transport over packet-oriented networks or storage into structured files, NAL units can be encapsulated into packets or similar structures. A bytestream format has been specified in H.264/AVC and HEVC for transmission or storage environments that do not provide framing structures. The bytestream format separates NAL units from each other by attaching a start code in front of each NAL unit. To avoid false detection of NAL unit boundaries, encoders run a byte-oriented start code emulation prevention algorithm, which adds an emulation prevention byte to the NAL unit payload if a start code would have occurred otherwise. In order to enable straightforward gateway operation between packet- and stream-oriented systems, start code emulation prevention is performed always regardless of whether the bytestream format is in use or not.

NAL units consist of a header and payload. In H.264/AVC, the NAL unit header indicates the type of the NAL unit and whether a coded slice contained in the NAL unit is a part of a reference picture or a non-reference picture.

H.264/AVC includes a 2-bit nal_ref_idc syntax element, which when equal to 0 indicates that a coded slice contained in the NAL unit is a part of a non-reference picture and when greater than 0 indicates that a coded slice contained in the NAL unit is a part of a reference picture. A draft HEVC standard includes a 1-bit nal_ref_idc syntax element, also known as nal_ref_flag, which when equal to 0 indicates that a coded slice contained in the NAL unit is a part of a non-reference picture and when equal to 1 indicates that a coded slice contained in the NAL unit is a part of a reference picture, while in another draft of the HEVC standard no nal_ref_idc syntax element is present in the NAL unit header but the information whether the picture is a reference picture or a non-reference picture may be concluded from reference picture sets used for the picture. The header for SVC and MVC NAL units additionally contains various indications related to the scalability and multiview hierarchy.

In a draft HEVC standard, a two-byte NAL unit header is used for all specified NAL unit types. The first byte of the NAL unit header contains one reserved bit, a one-bit indication nal_ref_flag primarily indicating whether the picture carried in this access unit is a reference picture or a non-reference picture, and a six-bit NAL unit type indication. The second byte of the NAL unit header includes a three-bit temporal_id indication for temporal level and a five-bit reserved field (called reserved_one_{—}5 bits) required to have a value equal to 1 in a draft HEVC standard. The temporal_id syntax element may be regarded as a temporal identifier for the NAL unit and TemporalId variable may be defined to be equal to the value of temporal_id. The five-bit reserved field is expected to be used by extensions such as a future scalable and 3D video extension. Without loss of generality, in some example embodiments a variable LayerId is derived from the value of reserved_one_{—}5 bits for example as follows: LayerId=reserved_one_{—}5 bits−1.

In a later draft HEVC standard, a two-byte NAL unit header is used for all specified NAL unit types. The NAL unit header contains one reserved bit, a six-bit NAL unit type indication, a six-bit reserved field (called reserved zero_{—}6 bits) and a three-bit temporal_id_plus1 indication for temporal level. The temporal_id_plus1 syntax element may be regarded as a temporal identifier for the NAL unit, and a zero-based TemporalId variable may be derived as follows: TemporalId=temporal=id_plus1−1. TemporalId equal to 0 corresponds to the lowest temporal level. The value of temporal_id_plus1 is required to be non-zero in order to avoid start code emulation involving the two NAL unit header bytes. Without loss of generality, in some example embodiments a variable LayerId is derived from the value of reserved_zero_{—}6 bits for example as follows: LayerId=reserved_zero_{—}6 bits.

It is expected that reserved_one_{—}5 bits, reserved_zero_{—}6 bits and/or similar syntax elements in NAL unit header would carry information on the scalability hierarchy. For example, the LayerId value derived from reserved_one_{—}5 bits, reserved_zero_{—}6 bits and/or similar syntax elements may be mapped to values of variables or syntax elements describing different scalability dimensions, such as quality_id or similar, dependency_id or similar, any other type of layer identifier, view order index or similar, view identifier, an indication whether the NAL unit concerns depth or texture i.e. depth_flag or similar, or an identifier similar to priority_id of SVC indicating a valid sub-bitstream extraction if all NAL units greater than a specific identifier value are removed from the bitstream. reserved_one_{—}5 bits, reserved_zero_{—}6 bits and/or similar syntax elements may be partitioned into one or more syntax elements indicating scalability properties. For example, a certain number of bits among reserved_one_{—}5 bits, reserved_zero_{—}6 bits and/or similar syntax elements may be used for dependency_id or similar, while another certain number of bits among reserved_one_{—}5 bits, reserved_zero_{—}6 bits and/or similar syntax elements may be used for quality_id or similar. Alternatively, a mapping of LayerId values or similar to values of variables or syntax elements describing different scalability dimensions may be provided for example in a Video Parameter Set, a Sequence Parameter Set or another syntax structure.

A coded picture is a coded representation of a picture. A coded picture in H.264/AVC consists of the VCL NAL units that are required for the decoding of the picture. In H.264/AVC, a coded picture can be a primary coded picture or a redundant coded picture. A primary coded picture is used in the decoding process of valid bitstreams, whereas a redundant coded picture is a redundant representation that should only be decoded when the primary coded picture cannot be successfully decoded. In a draft HEVC, no redundant coded picture has been specified.

In H.264/AVC and HEVC, an access unit consists of a primary coded picture and those NAL units that are associated with it. In H.264/AVC, the appearance order of NAL units within an access unit is constrained as follows. An optional access unit delimiter NAL unit may indicate the start of an access unit. It is followed by zero or more SEI NAL units. The coded slices of the primary coded picture appear next, followed by coded slices for zero or more redundant coded pictures.

In H.264/AVC, a coded video sequence is defined to be a sequence of consecutive access units in decoding order from an IDR access unit, inclusive, to the next IDR access unit, exclusive, or to the end of the bitstream, whichever appears earlier.

Many hybrid video codecs, including ITU-T H.263, H.264/AVC and HEVC, encode video information in two phases. In the first phase, pixel or sample values in a certain picture area or “block” are predicted. These pixel or sample values can be predicted, for example, by motion compensation mechanisms, which involve finding and indicating an area in one of the previously encoded video frames that corresponds closely to the block being coded. Additionally, pixel or sample values can be predicted by spatial mechanisms which involve finding and indicating a spatial region relationship.

Prediction approaches using image information from a previously coded image can also be called as inter prediction methods which may be also referred to as temporal prediction and motion compensation. Prediction approaches using image information within the same image can also be called as intra prediction methods.

The second phase is one of coding the error between the predicted block of pixels or samples and the original block of pixels or samples. This may be accomplished by transforming the difference in pixel or sample values using a specified transform. This transform may be a Discrete Cosine Transform (DCT) or a variant thereof. After transforming the difference, the transformed difference is quantized and entropy encoded.

By varying the fidelity of the quantization process, the encoder can control the balance between the accuracy of the pixel or sample representation (i.e. the visual quality of the picture) and the size of the resulting encoded video representation (i.e. the file size or transmission bit rate).

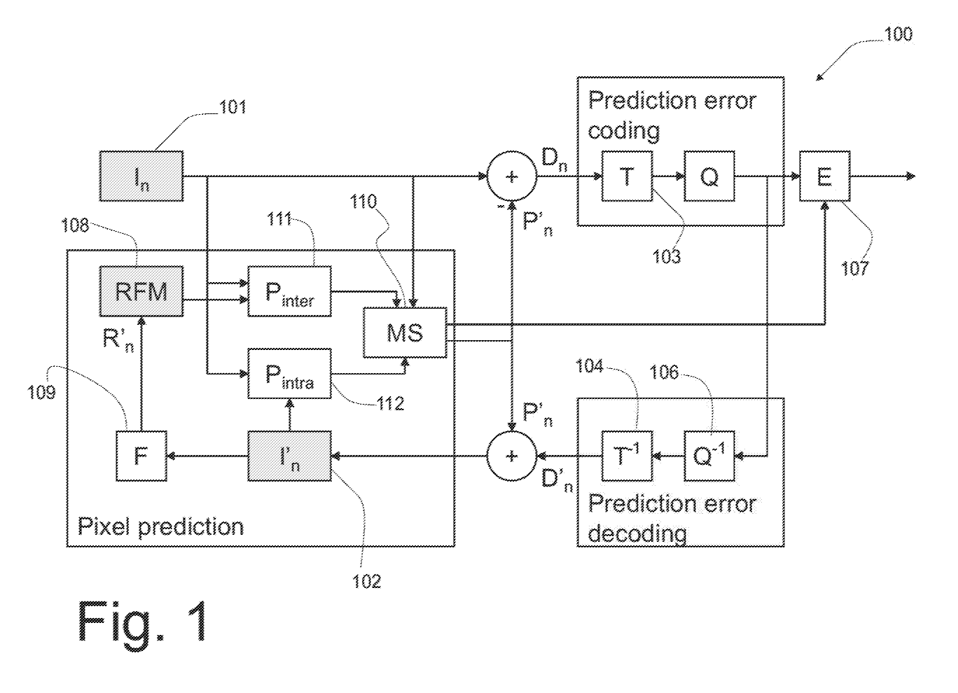

FIG. 1 illustrates an embodiment of a video coder 100 of related art as a block diagram. In the figure, block 101 represents the image to be encoded (Iₙ). Reference P′ₙ represents the predicted representation of an image block and reference Dₙ represents the prediction error signal, whereas the reconstructed prediction error signal is represented with reference D′ₙ.

Block 102 represents the preliminary reconstructed image (I′ₙ). Reference R′ₙ stands for final reconstructed image. Block 103 is for transform (T) and block 104 is for inverse transform (T⁻¹). Block 105 is for quantization (Q) and block 106 is for inverse quantization (Q⁻¹). Block 107 is for entropy coding (E). Block 108 illustrates reference frame memory (RFM). Block 109 illustrates filtering (F). Block 110 illustrates mode selection (MS). Block 111 illustrates inter prediction (Pᵢₙₜₑᵣ) and block 112 illustrates intra prediction (Pᵢₙₜᵣₐ).

The decoder reconstructs the output video by applying a prediction mechanism similar to that used by the encoder in order to form a predicted representation of the pixel or sample blocks (using the motion or spatial information created by the encoder and stored in the compressed representation of the image) and prediction error decoding (the inverse operation of the prediction error coding to recover the quantized prediction error signal in the spatial domain).

After applying pixel or sample prediction and error decoding processes the decoder combines the prediction and the prediction error signals (the pixel or sample values) to form the output video frame.

The decoder (and encoder) may also apply additional filtering processes in order to improve the quality of the output video before passing it for display and/or storing as a prediction reference for the forthcoming pictures in the video sequence.

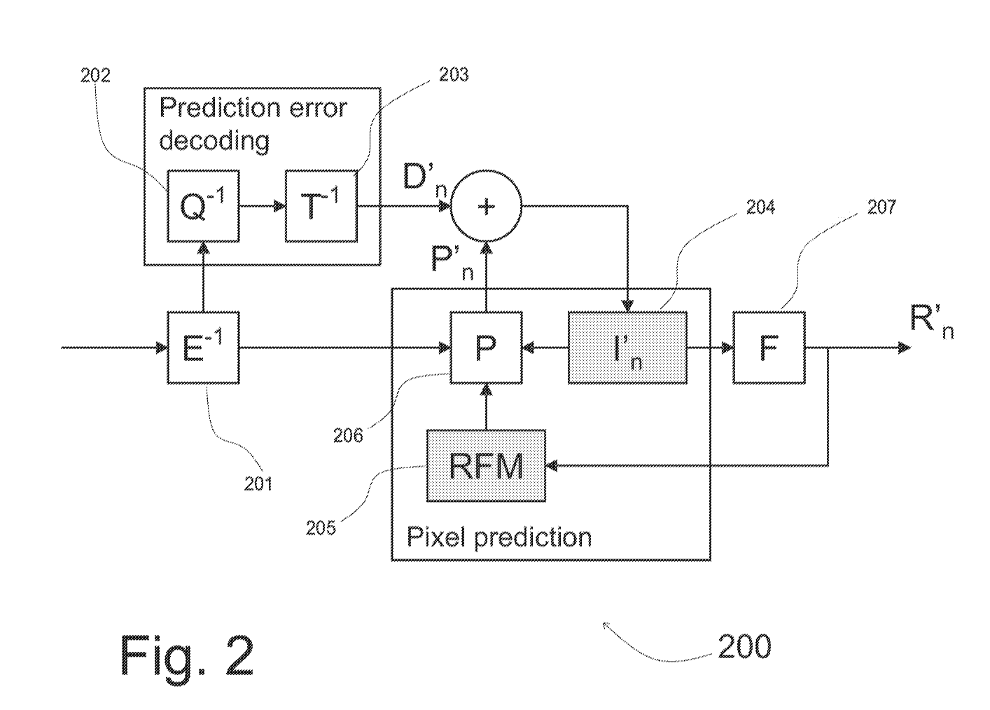

FIG. 2 illustrates an embodiment of a video decoder 200 of related art as a block diagram. Reference P′ₙ stands for a predicted representation of an image block. Reference D′ₙ stands for a reconstructed prediction error signal. Block 204 illustrates a preliminary reconstructed image (I′ₙ). Reference R′ₙ stands for a final reconstructed image. Block 203 illustrates inverse transform (T⁻¹). Block 202 illustrates inverse quantization (Q⁻¹). Block 201 illustrates entropy decoding (E⁻¹). Block 205 illustrates a reference frame memory (RFM). Block 206 illustrates prediction (P) (either inter prediction or intra prediction). Block 207 illustrates filtering (F).

In many video codecs, including H.264/AVC and HEVC, motion information is indicated by motion vectors associated with each motion compensated image block. Each of these motion vectors represents the displacement of the image block in the picture to be coded (in the encoder) or decoded (at the decoder) and the prediction source block in one of the previously coded or decoded images (or pictures).

In many video codecs the predicted motion vectors are created in a predefined way, for example calculating the median of the encoded or decoded motion vectors of the adjacent blocks. Another way to create motion vector predictions is to generate a list of candidate predictions from adjacent blocks and/or co-located blocks in temporal reference pictures and signalling the chosen candidate as the motion vector predictor. In addition to predicting the motion vector values, the reference index of previously coded/decoded picture can be predicted. The reference index is typically predicted from adjacent blocks and/or or co-located blocks in temporal reference picture. Moreover, typical high efficiency video codecs employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information is carried out using the motion field information of adjacent blocks and/or co-located blocks in temporal reference pictures and the used.

In many video codecs, the prediction residual after motion compensation is first transformed with a transform kernel (like DCT) and then coded. The reason for this is that often there still exists some correlation among the residual and transform can in many cases help reduce this correlation and provide more efficient coding.

H.264/AVC and HEVC enable the use of a single prediction block in P slices (herein referred to as uni-predictive slices) or a linear combination of two motion-compensated prediction blocks for bi-predictive slices, which are also referred to as B slices. Individual blocks in B slices may be bi-predicted, uni-predicted, or intra-predicted, and individual blocks in P slices may be uni-predicted or intra-predicted. The reference pictures for a bi-predictive picture may not be limited to be the subsequent picture and the previous picture in output order, but rather any reference pictures may be used. In many coding standards, such as H.264/AVC and HEVC, one reference picture list, referred to as reference picture list 0, is constructed for P slices, and two reference picture lists, list 0 and list 1, are constructed for B slices. For B slices, prediction in forward direction may refer to prediction from a reference picture in reference picture list 0, and prediction in backward direction may refer to prediction from a reference picture in reference picture list 1, even though the reference pictures for prediction may have any decoding or output order relation to each other or to the current picture.

Many coding standards use a prediction weight of 1 for prediction blocks of inter (P) pictures and 0.5 for each prediction block of a B picture (resulting into averaging). H.264/AVC and HEVC allow weighted prediction for both P and B slices. In implicit weighted prediction, the weights are proportional for example to picture order counts, while in explicit weighted prediction, prediction weights are explicitly indicated by the encoder in the bitstream and decoded from the bitstream and used by the decoder. In explicit weighted prediction, a luma prediction weight and a chroma prediction weight may for example be indicated for each reference index in a reference picture list for example in a prediction weight syntax structure which may be included in a slice header.

Some known video encoders utilize Lagrangian cost functions to find optimal coding modes, e.g. the desired Macroblock mode and associated motion vectors. This kind of cost function uses a weighting factor to tie together the (exact or estimated) image distortion due to lossy coding methods and the (exact or estimated) amount of information that is required to represent the pixel values in an image area:

C=D+R (Eq. 1)

where C is the Lagrangian cost to be minimized, D is the image distortion (e.g. Mean Squared Error) with the mode and motion vectors considered, and R the number of bits needed to represent the required data to reconstruct the image block in the decoder (including the amount of data to represent the candidate motion vectors).

In many video codecs, including H.264/AVC and HEVC, motion information is indicated by motion vectors associated with each motion compensated image block. Each of these motion vectors represents the displacement of the image block in the picture to be coded (in the encoder) or decoded (at the decoder) and the prediction source block in one of the previously coded or decoded images (or pictures). H.264/AVC and HEVC, as many other video compression standards, divides a picture into a mesh of rectangles, for each of which a similar block in one of the reference pictures is indicated for inter prediction. The location of the prediction block is coded as motion vector that indicates the position of the prediction block compared to the block being coded.

In order to represent motion vectors efficiently the motion vectors may be coded differentially with respect to block specific predicted motion vectors. In many video codecs the predicted motion vectors are created in a predefined way, for example by calculating the median of the encoded or decoded motion vectors of the adjacent blocks. Another way to create motion vector predictions, sometimes referred to as advanced motion vector prediction (AMVP), is to generate a list of candidate predictions from adjacent blocks and/or co-located blocks in temporal reference pictures and signalling the chosen candidate as the motion vector predictor.

H.264/AVC specifies the process for decoded reference picture marking in order to control the memory consumption in the decoder. The maximum number of reference pictures used for inter prediction, referred to as M, is determined in the sequence parameter set. When a reference picture is decoded, it is marked as “used for reference”. If the decoding of the reference picture caused more than M pictures marked as “used for reference”, at least one picture is marked as “unused for reference”. There are two types of operation for decoded reference picture marking: adaptive memory control and sliding window. The operation mode for decoded reference picture marking is selected on picture basis. The adaptive memory control enables explicit signaling which pictures are marked as “unused for reference” and may also assign long-term indices to short-term reference pictures. The adaptive memory control may require the presence of memory management control operation (MMCO) parameters in the bitstream. MMCO parameters may be included in a decoded reference picture marking syntax structure. If the sliding window operation mode is in use and there are M pictures marked as “used for reference”, the short-term reference picture that was the first decoded picture among those short-term reference pictures that are marked as “used for reference” is marked as “unused for reference”. In other words, the sliding window operation mode results into first-in-first-out buffering operation among short-term reference pictures.

One of the memory management control operations in H.264/AVC causes all reference pictures except for the current picture to be marked as “unused for reference”. An instantaneous decoding refresh (IDR) picture contains only intra-coded slices and causes a similar “reset” of reference pictures.

In a draft HEVC standard, reference picture marking syntax structures and related decoding processes are not used, but instead a reference picture set (RPS) syntax structure and decoding process are used instead for a similar purpose. A reference picture set valid or active for a picture includes all the reference pictures used as reference for the picture and all the reference pictures that are kept marked as “used for reference” for any subsequent pictures in decoding order. There are six subsets of the reference picture set, which are referred to as namely RefPicSetStCurr0, RefPicSetStCurr1, RefPicSetStFoll0, RefPicSetStFoll1, RefPicSetLtCurr, and RefPicSetLtFoll. The notation of the six subsets is as follows. “Curr” refers to reference pictures that are included in the reference picture lists of the current picture and hence may be used as inter prediction reference for the current picture. “Foll” refers to reference pictures that are not included in the reference picture lists of the current picture but may be used in subsequent pictures in decoding order as reference pictures. “St” refers to short-term reference pictures, which may generally be identified through a certain number of least significant bits of their POC value. “Lt” refers to long-term reference pictures, which are specifically identified and generally have a greater difference of POC values relative to the current picture than what can be represented by the mentioned certain number of least significant bits. “0” refers to those reference pictures that have a smaller POC value than that of the current picture. “1” refers to those reference pictures that have a greater POC value than that of the current picture. RefPicSetStCurr0, RefPicSetStCurr1, RefPicSetStFoll0 and RefPicSetStFoll1 are collectively referred to as the short-term subset of the reference picture set. RefPicSetLtCurr and RefPicSetLtFoll are collectively referred to as the long-term subset of the reference picture set.

In a draft HEVC standard, a reference picture set may be specified in a sequence parameter set and taken into use in the slice header through an index to the reference picture set. A reference picture set may also be specified in a slice header. A long-term subset of a reference picture set is generally specified only in a slice header, while the short-term subsets of the same reference picture set may be specified in the picture parameter set or slice header. A reference picture set may be coded independently or may be predicted from another reference picture set (known as inter-RPS prediction). When a reference picture set is independently coded, the syntax structure includes up to three loops iterating over different types of reference pictures; short-term reference pictures with lower POC value than the current picture, short-term reference pictures with higher POC value than the current picture and long-term reference pictures. Each loop entry specifies a picture to be marked as “used for reference”. In general, the picture is specified with a differential POC value. The inter-RPS prediction exploits the fact that the reference picture set of the current picture can be predicted from the reference picture set of a previously decoded picture. This is because all the reference pictures of the current picture are either reference pictures of the previous picture or the previously decoded picture itself. It is only necessary to indicate which of these pictures should be reference pictures and be used for the prediction of the current picture. In both types of reference picture set coding, a flag (used_by_curr_pic_X_flag) is additionally sent for each reference picture indicating whether the reference picture is used for reference by the current picture (included in a *Curr list) or not (included in a *Foll list). Pictures that are included in the reference picture set used by the current slice are marked as “used for reference”, and pictures that are not in the reference picture set used by the current slice are marked as “unused for reference”. If the current picture is an IDR picture, RefPicSetStCurr0, RefPicSetStCurr1, RefPicSetStFoll0, RefPicSetStFoll1, RefPicSetLtCurr, and RefPicSetLtFoll are all set to empty.

Many coding standards allow the use of multiple reference pictures for inter prediction. Many coding standards, such as H.264/AVC and HEVC, include syntax structures in the bitstream that enable decoders to create one or more reference picture lists to be used in inter prediction when more than one reference picture may be used. A reference picture index to a reference picture list may be used to indicate which one of the multiple reference pictures is used for inter prediction for a particular block. A reference picture index or any other similar information identifying a reference picture may therefore be associated with or considered part of a motion vector. A reference picture index may be coded by an encoder into the bitstream in some inter coding modes or it may be derived (by an encoder and a decoder) for example using neighboring blocks in some other inter coding modes. In many coding modes of H.264/AVC and HEVC, the reference picture for inter prediction is indicated with an index to a reference picture list. The index may be coded with variable length coding, which usually causes a smaller index to have a shorter value for the corresponding syntax element. In H.264/AVC and HEVC, two reference picture lists (reference picture list 0 and reference picture list 1) are generated for each bi-predictive (B) slice, and one reference picture list (reference picture list 0) is formed for each inter-coded (P) slice. In addition, for a B slice in a draft HEVC standard, a combined list (List C) may be constructed after the final reference picture lists (List 0 and List 1) have been constructed. The combined list may be used for uni-prediction (also known as uni-directional prediction) within B slices.

A reference picture list, such as reference picture list 0 and reference picture list 1, is typically constructed in two steps: First, an initial reference picture list is generated. The initial reference picture list may be generated for example on the basis of frame_num, POC, temporal_id, or information on the prediction hierarchy such as GOP (Group of Pictures) structure, or any combination thereof. Second, the initial reference picture list may be reordered by reference picture list reordering (RPLR) commands, also known as reference picture list modification syntax structure, which may be contained in slice headers. The RPLR commands indicate the pictures that are ordered to the beginning of the respective reference picture list. This second step may also be referred to as the reference picture list modification process, and the RPLR commands may be included in a reference picture list modification syntax structure. If reference picture sets are used, the reference picture list 0 may be initialized to contain RefPicSetStCurr0 first, followed by RefPicSetStCurr1, followed by RefPicSetLtCurr. Reference picture list 1 may be initialized to contain RefPicSetStCurr1 first, followed by RefPicSetStCurr0. The initial reference picture lists may be modified through the reference picture list modification syntax structure, where pictures in the initial reference picture lists may be identified through an entry index to the list. Moreover, the number of pictures in a reference picture list may be limited for example using num_ref_idx_{—}10_active_minus1 and (for B slices) num_ref_idx_{—}11_active_minus1 syntax elements of a draft HEVC standard, which may be included in a slice header. The same picture may appear multiple times in a reference picture list, which may be used for example when a different weight for weighted prediction is used for each occurrence of the same picture.

The combined list in a draft HEVC standard may be constructed as follows. If the modification flag for the combined list is zero, the combined list is constructed by an implicit mechanism; otherwise it is constructed by reference picture combination commands included in the bitstream. In the implicit mechanism, reference pictures in List C are mapped to reference pictures from List 0 and List 1 in an interleaved fashion starting from the first entry of List 0, followed by the first entry of List 1 and so forth. Any reference picture that has already been mapped in List C is not mapped again. In the explicit mechanism, the number of entries in List C is signaled, followed by the mapping from an entry in List 0 or List 1 to each entry of List C. In addition, when List 0 and List 1 are identical the encoder has the option of setting the ref_pic_list_combination_flag to 0 to indicate that no reference pictures from List 1 are mapped, and that List C is equivalent to List 0.

A Decoded Picture Buffer (DPB) may be used in the encoder and/or in the decoder. There are two reasons to buffer decoded pictures, for references in inter prediction and for reordering decoded pictures into output order. As H.264/AVC and HEVC provide a great deal of flexibility for both reference picture marking and output reordering, separate buffers for reference picture buffering and output picture buffering may waste memory resources. Hence, the DPB may include a unified decoded picture buffering process for reference pictures and output reordering. A decoded picture may be removed from the DPB when it is no longer used as reference and needed for output.

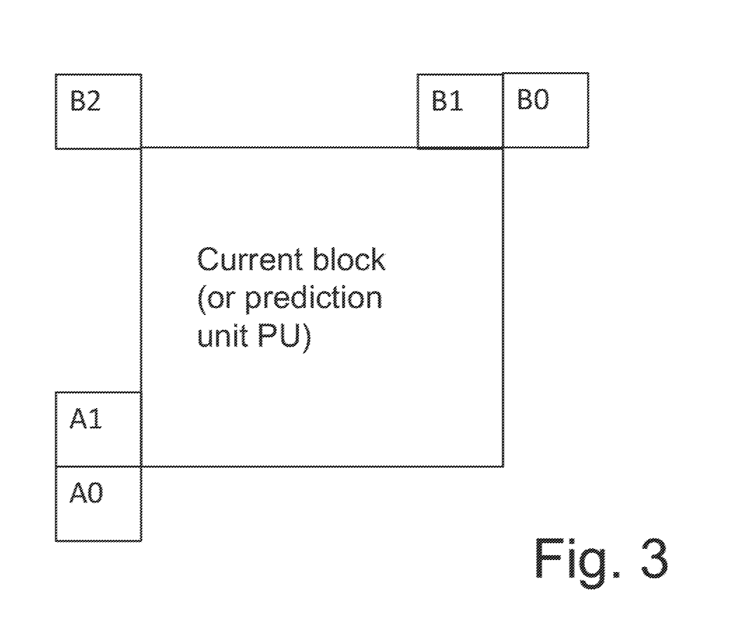

AMVP may operate for example as follows, while other similar realizations of AMVP are also possible for example with different candidate position sets and candidate locations with candidate position sets. Two spatial motion vector predictors (MVPs) may be derived and a temporal motion vector predictor (TMVP) may be derived. They are selected among the positions shown in FIG. 3: three spatial MVP candidate positions located above the current prediction block (B0, B1, B2) and two on the left (A0, A1). The first motion vector predictor that is available (e.g. resides in the same slice, is inter-coded, etc.) in a pre-defined order of each candidate position set, (B0, B1, B2) or (A0, A1), may be selected to represent that prediction direction (up or left) in the motion vector competition. A reference index for TMVP may be indicated by the encoder in the slice header (e.g. as collocated_ref_idx syntax element). The motion vector obtained from the co-located picture may be scaled according to the proportions of the picture order count differences of the reference picture of TMVP, the co-located picture, and the current picture. Moreover, a redundancy check may be performed among the candidates to remove identical candidates, which can lead to the inclusion of a zero MV in the candidate list. The motion vector predictor may be indicated in the bitstream for example by indicating the direction of the spatial MVP (up or left) or the selection of the TMVP candidate.

In addition to predicting the motion vector values, the reference index of previously coded/decoded picture can be predicted. The reference index may be predicted from adjacent blocks and/or from co-located blocks in a temporal reference picture.

Moreover, many high efficiency video codecs employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information is carried out using the motion field information of adjacent blocks and/or co-located blocks in temporal reference pictures and the used motion field information is signalled among a list of motion field candidate list filled with motion field information of available adjacent/co-located blocks.

In a merge mode, all the motion information of a block/PU may be predicted and used without any modification/correction. The aforementioned motion information for a PU may comprise
1) The information whether ‘the PU is uni-predicted using only reference picture list0’ or ‘the PU is uni-predicted using only reference picture list1’ or ‘the PU is bi-predicted using both reference picture list0 and list1’
2) Motion vector value corresponding to the reference picture list0
3) Reference picture index in the reference picture list0
4) Motion vector value corresponding to the reference picture list1
5) Reference picture index in the reference picture list1.

Similarly, predicting the motion information may be carried out using the motion information of adjacent blocks and/or co-located blocks in temporal reference pictures. A list, often called as merge list, may be constructed by including motion prediction candidates associated with available adjacent/co-located blocks and the index of selected motion prediction candidate in the list is signalled. Then the motion information of the selected candidate can be copied to the motion information of the current PU. When the merge mechanism is employed for a whole CU and the prediction signal for the CU is used as the reconstruction signal, i.e. prediction residual is not processed, this type of coding/decoding the CU is typically named as skip mode or merge based skip mode. In addition to the skip mode, the merge mechanism is also employed for individual PUs (not necessarily the whole CU as in skip mode) and in this case, prediction residual may be utilized to improve prediction quality. This type of prediction mode is typically named as inter-merge mode.

After motion compensation followed by adding inverse transformed residual, a reconstructed picture is obtained. This picture usually has various artifacts such as blocking, ringing etc. In order to eliminate the artifacts, various post-processing operations may be applied. If the post-processed pictures are used as reference in the motion compensation loop, then the post-processing operations/filters are usually called loop filters. By employing loop filters, the quality of the reference pictures can be increased. As a result, better coding efficiency can be achieved.

One of the loop filters is deblocking filter. Deblocking filter is available in both H.264/AVC and HEVC standards. The aim of the deblocking filter is to remove the blocking artifacts occurring in the boundaries of the blocks. This may be achieved by filtering along the block boundaries.

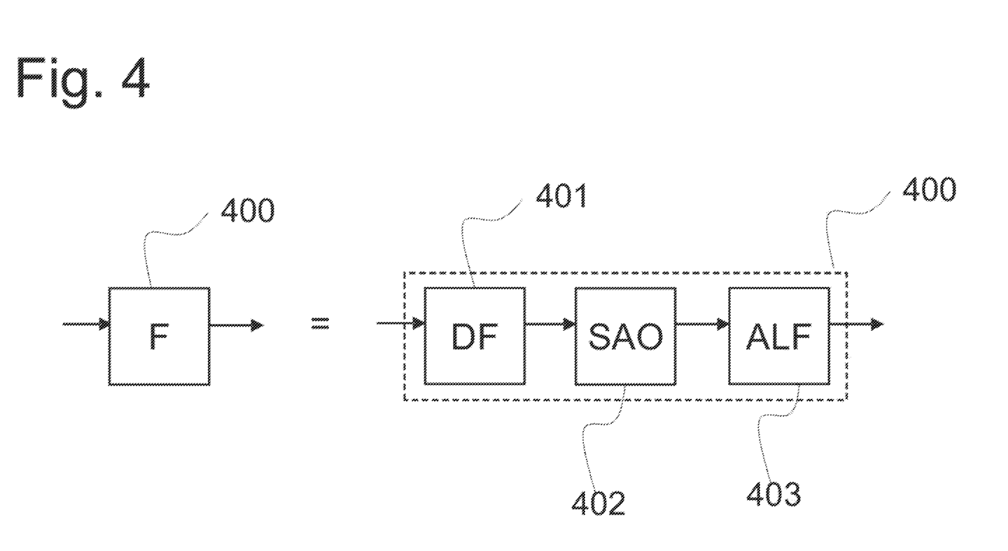

In HEVC, there are two new loop filters compared to H.264/AVC. These loop filters are Sample Adaptive Offset (SAO) and Adaptive Loop Filter (ALF). SAO is applied after the deblocking filtering and ALF is applied after SAO. FIG. 4 illustrates the filtering block (F) shown in FIGS. 1 and 2 (109, 207 respectively) as a block diagram. Filtering block 400 may be consisted of deblocking filter (DF) 401; sample adaptive offset (SAO) 402; and adaptive loop filter (ALF) 403.

### Sample Adaptive Offset

The SAO algorithm is described next as present in the latest HEVC standard specification. In SAO, the picture is divided into regions where a separate SAO decision is made for each region. The SAO information in a region is encapsulated in SAO parameters adaptation unit (SAO unit) and in HEVC, the basic unit for adapting SAO parameters is CTU (therefore an SAO region is the block covered by the corresponding CTU).

In SAO algorithm, samples in a CTU can be classified according to a set of rules and each classified set of samples may be enhanced by adding offset values. The offset values can be signalled in the bitstream. There are at least two types of offsets: 1) Band offset 2) Edge offset. For a CTU, either no SAO or band offset or edge offset is employed. Choice of whether no SAO or band or edge offset to be used is typically decided by encoder with RDO (Rate-Distortion Optimization) and signaled to the decoder.

In band offset, the whole range of sample values is divided into 32 equal-width bands. For example, for 8-bit samples, width of a band is 8 (=256/32). Out of 32 bands, 4 of them may be selected and different offsets are signalled for each of the selected band. The selection decision is made by the encoder and signalled as follows: The index of the first band is signalled and then it is inferred that following 4 bands are the chosen ones. Band offset is usually useful in correcting errors in smooth regions.

In the edge offset type, first of all, the edge offset (EO) type may be chosen out of four possible types (or edge classifications) where each type may be associated with a direction: 1) vertical 2) horizontal 3) 135 deg diagonal and 4) 45 deg diagonal. The choice of the direction is given by the encoder and signalled to the decoder. Each type defines the location of two neighbour samples for a given sample based on the angle. Then each sample in the CTU is classified into one of five categories based on comparison of the sample value against the values of the two neighbour samples. The five categories are described as follows:
Current sample value is smaller than the two neighbour samples
Current sample value is smaller than one of the neighbors and equal to the other neighbor
Current sample value is greater than one of the neighbors and equal to the other neighbor
Current sample value is greater than two neighbour samples
None of the above

These five categories are not required to be signalled to the decoder because the classification is based on only reconstructed samples, which are available and identical in both the encoder and decoder. After each sample in an edge offset type CTU is classified as one of the five categories, an offset value for each of the first four categories is determined and signalled to the decoder. The offset for each category may be added to the sample values associated with the corresponding category. Edge offsets are usually effective in correcting ringing artifacts.

The SAO parameters may be signalled as interleaved in CTU data. Above CTU, slice header may contain a syntax element specifying whether SAO is used in the slice. If SAO is used, then two additional syntax elements specify whether SAO is applied to Cb and Cr components. For each CTU, there are three options: 1) copying SAO parameters from the left CTU 2) copying SAO parameters from the above CTU or 3) signalling new SAO parameters.

### Adaptive Loop Filter

Adaptive loop filter (ALF) is another method to enhance quality of the reconstructed samples. This is achieved by filtering the sample values in the loop. Typically, the encoder determines which region of the pictures are to be filtered and the filter coefficients based on RDO and this information is signalled to the decoder.

H.264/AVC and HEVC include a concept of picture order count (POC). A value of POC is derived for each picture and is non-decreasing with increasing picture position in output order. POC therefore indicates the output order of pictures. POC may be used in the decoding process for example for implicit scaling of motion vectors in the temporal direct mode of bi-predictive slices and/or for implicitly derived weights in weighted prediction and/or for reference picture list initialization and/or to identify pictures and/or for deriving motion parameters in merge mode and motion vector prediction. Furthermore, POC may be used in the verification of output order conformance

Scalable video coding refers to coding structure where one bitstream can contain multiple representations of the content at different bitrates, resolutions or frame rates. In these cases the receiver can extract the desired representation depending on its characteristics (e.g. resolution that matches best the display device). Alternatively, a server or a network element can extract the portions of the bitstream to be transmitted to the receiver depending on e.g. the network characteristics or processing capabilities of the receiver. A scalable bitstream may consist of a “base layer” providing the lowest quality video available and one or more enhancement layers that enhance the video quality when received and decoded together with the lower layers. In order to improve coding efficiency for the enhancement layers, the coded representation of that layer typically depends on the lower layers. E.g. the motion and mode information of the enhancement layer can be predicted from lower layers. Similarly the pixel data of the lower layers can be used to create prediction for the enhancement layer.

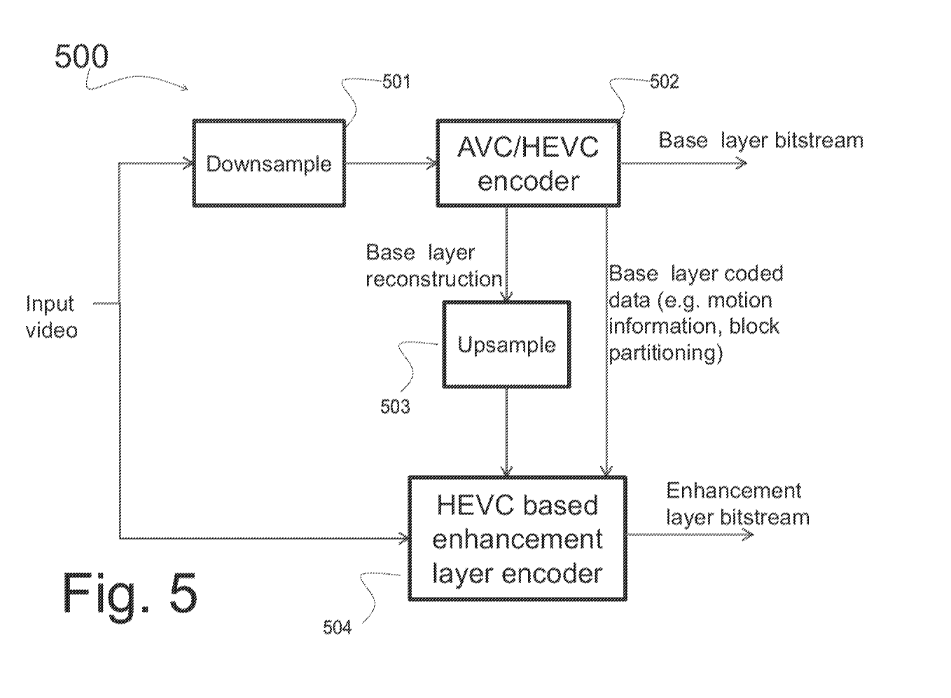

A scalable video codec for quality scalability (also known as Signal-to-Noise or SNR) and/or spatial scalability may be implemented as follows. For a base layer, a conventional non-scalable video encoder and decoder may be used. The reconstructed/decoded pictures of the base layer can be included in the reference picture buffer for an enhancement layer. In H.264/AVC, HEVC, and similar codecs using reference picture list(s) for inter prediction, the base layer decoded pictures may be inserted into a reference picture list(s) for coding/decoding of an enhancement layer picture similarly to the decoded reference pictures of the enhancement layer. Consequently, the encoder may choose a base layer reference picture as inter prediction reference and indicate its use typically with a reference picture index in the coded bitstream. The decoder is configured to decode from the bitstream, for example from a reference picture index, that a base-layer picture is used as inter prediction reference for the enhancement layer. When a decoded base layer picture is used as prediction reference for an enhancement layer, it is referred to as an inter-layer reference picture. FIG. 5 illustrates an example of a spatial scalability encoder 500 with a HEVC based enhancement layer encoder (504). In an embodiment of the encoder 500, the encoder does not comprises downsample (501) or upsample (503), as shown in FIG. 5. Such a video coder is configured for quality scalability.

Another type of scalability is standard scalability. When the encoder 500 uses other coder than HEVC (502) in the base layer, such an encoder is for standard scalability. In this type, the base layer and enhancement layer belong to different video coding standards. An example case is where the base layer is coded with H.264/AVC whereas the enhancement layer is coded with HEVC. The motivation behind this type of scalability is that in this way, the same bitstream can be decoded by both legacy H.264/AVC based systems as well as new HEVC based systems.

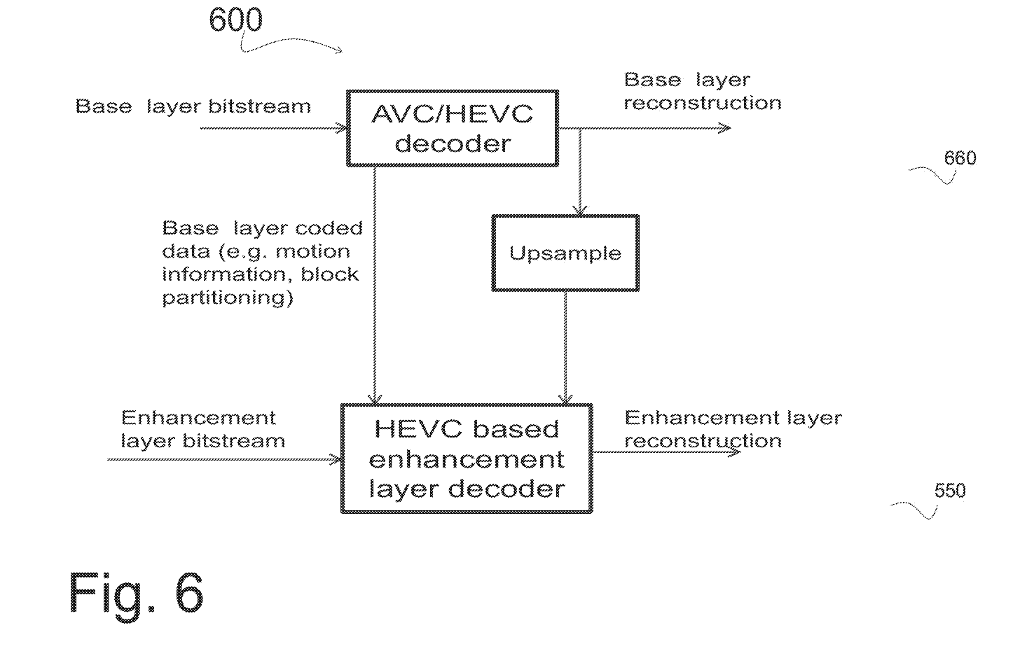

FIG. 6 illustrates a block diagram of a decoder corresponding to the encoder 500 shown in FIG. 5.

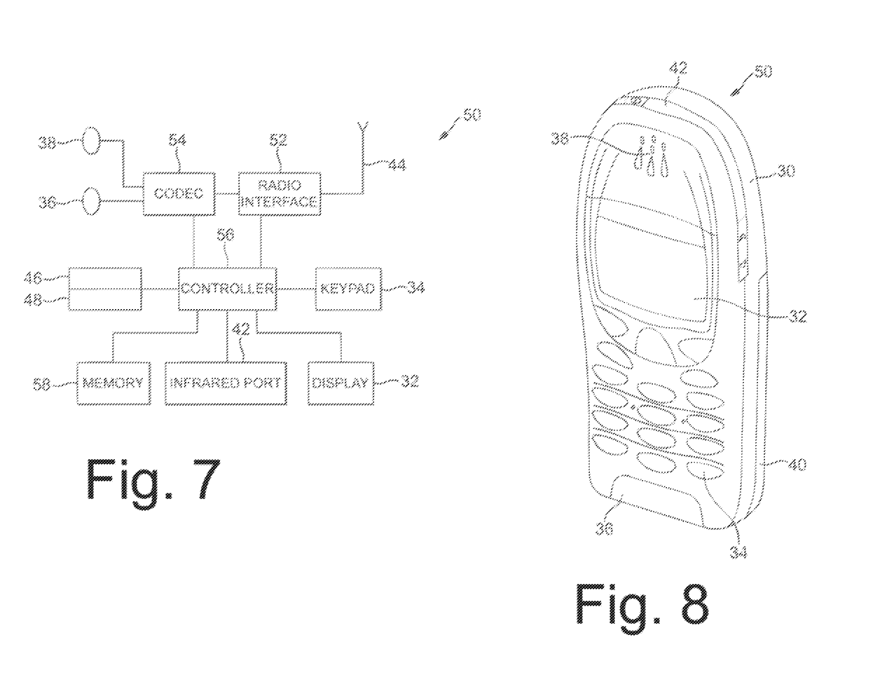

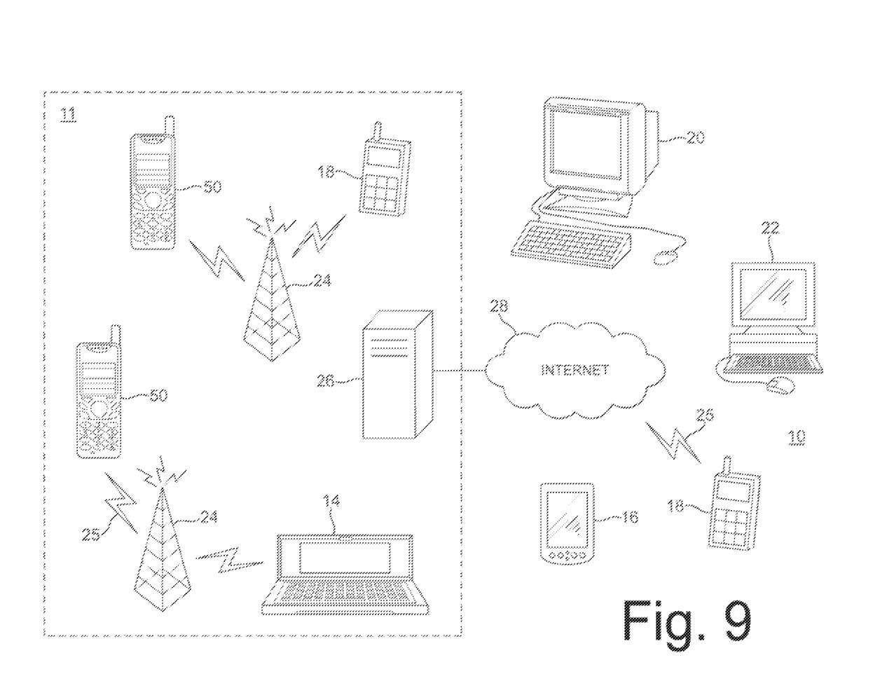

FIG. 7 shows a block diagram of a video coding system according to an example embodiment as a schematic block diagram of an exemplary apparatus or electronic device 50, which may incorporate a codec according to an embodiment of the invention. FIG. 8 shows a layout of an apparatus according to an example embodiment. The elements of FIGS. 7 and 8 will be explained next.

The electronic device 50 may for example be a mobile terminal or user equipment of a wireless communication system. However, it would be appreciated that embodiments of the invention may be implemented within any electronic device or apparatus which may require encoding and decoding or encoding or decoding video images.

The apparatus 50 may comprise a housing 30 for incorporating and protecting the device. The apparatus 50 further may comprise a display 32 in the form of e.g. a liquid crystal display. In other embodiments of the invention the display may be any suitable display technology suitable to display an image or video. The apparatus 50 may further comprise a keypad 34. In other embodiments of the invention any suitable data or user interface mechanism may be employed. For example the user interface may be implemented as a virtual keyboard or data entry system as part of a touch-sensitive display. The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery 40 (or in other embodiments of the invention the device may be powered by any suitable mobile energy device such as solar cell, fuel cell or clockwork generator). The apparatus may further comprise an infrared port 42 for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56 or processor for controlling the apparatus 50. The controller 56 may be connected to memory 58 which in embodiments of the invention may store both data in the form of image and audio data and/or may also store instructions for implementation on the controller 56. The controller 56 may further be connected to codec circuitry 54 suitable for carrying out coding and decoding of audio and/or video data or assisting in coding and decoding carried out by the controller 56.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

In some embodiments of the invention, the apparatus 50 comprises a camera capable of recording or detecting individual frames which are then passed to the codec 54 or controller for processing. In some embodiments of the invention, the apparatus may receive the video image data for processing from another device prior to transmission and/or storage. In some embodiments of the invention, the apparatus 50 may receive either wirelessly or by a wired connection the image for coding/decoding.

FIG. 9 shows an arrangement for video coding comprising a plurality of apparatuses, networks and network elements according to an example embodiment. With respect to FIG. 9, an example of a system within which embodiments of the present invention can be utilized is shown. The system 10 comprises multiple communication devices which can communicate through one or more networks. The system 10 may comprise any combination of wired or wireless networks including, but not limited to a wireless cellular telephone network (such as a GSM, UMTS, CDMA network etc), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices or apparatus 50 suitable for implementing embodiments of the invention. For example, the system shown in FIG. 9 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

Some or further apparatuses may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections, and any suitable connection

In video coders, such as HEVC, the motion field (motion vectors and reference indices) can be predicted either from spatially neighboring blocks or from blocks in different frames. For scalable video coding, the motion field could be also predicted from frames belonging to different layers. However, in such case, the reference index of the motion vector predictor in another layer cannot be directly utilized. There can be many reasons for that, for example the prediction structure of the enhancement layer may be different from the prediction structure of the base layer and/or reference picture marking (e.g. as “used for reference” and “unused for reference”) is different for the enhancement layer pictures compared to that of the base layer pictures and/or reference picture lists are ordered differently in the enhancement layer than in the base layer and/or the number of pictures in the reference picture lists in the enhancement layer is chosen to be different than that in the base layer. This means that the reference index of the base layer motion may correspond to a different picture in the reference picture list of the enhancement layer picture. As another reason, because the prediction structures are different, there may not be a reference picture associated with the reference index of the base layer motion field.

For example, if a reference picture list of a given picture at base layer has the pictures with POC values [10, 11, 12]. Further, if the prediction structure for enhancement layer is different from the base layer and the reference picture list of the same picture in enhancement layer contains the pictures with POC values [9, 10, 11]. Now, as an example, the motion field of the enhancement layer is copied from base layer and the base layer motion field has reference index 0 for a particular block. If the reference index of the base layer is copied blindly to the enhancement layer, the motion vectors would be pointing to a different picture, as the POC values of picture at reference index 0 is different for enhancement layer and base layer.

In H.264/SVC it is possible to predict reference indexes directly from reference layer to the current layer. Or in other words, a predicted reference index in enhancement layer is the minimum non-negative reference index (please note that intra coded blocks are considered to have a negative reference index) of the reference layer blocks that co-locate with the current enhancement layer block. The reference picture lists for different dependency representations are constructed independently. Therefore, the encoders need to use the same reference picture lists across layers to encode H.264/SVC bitstreams optimally.

The present embodiments propose to use a mapping table or a mapping process for each reference picture list. Then, a reference index of motion vector prediction from another layer can be derived using the mapping table or mapping process, instead of copying the reference index of motion vector in another layer.

A first embodiment is described next. Let us assume that the motion information of the block in enhancement layer is coded using the motion vector information in the corresponding block in base layer. The reference picture index of the base layer motion vector cannot be directly used as it might refer to a different picture than in enhancement layer. The reference picture index of the base layer motion vector is indicated as refIdxBase. The reference picture index which will be used for the enhancement layer motion vector is refIdxEnh.

The refIdxEnh can be derived by

refIdxEnh=refMapTable[LX][refIdxBase]

where LX can be either L0 or L1, depending on whether reference picture list 0 or list 1 is used.

The mapping from reference picture index to corresponding POC for base layer is denoted with POC=Ref2POCBase[LX][refIdxBase] and the same mapping for enhancement layer is denoted by POC=Ref2POCEnh[LX][RefIdxEnh] where LX can be either L0 or L1, depending on whether reference picture list 0 or list 1 is used.

The refMapTable may be initialized once per slice. This initialization can be performed by various means:
The values of refMapTable can be signaled in the bitstream to the decoder.
The values of the refMapTable can be derived using the corresponding POC values of the reference pictures in enhancement and base layer reference pictures. Such derivation can happen by:
   searching the reference list for both enhancement and base layer and deriving the refMapTable so that the POC value of reference picture at index refIdxBase in base reference picture list corresponds to the same POC value of reference picture at index refIdxEnh in enhancement reference picture list.
   Furthermore, the searching can take into account the corresponding weighted prediction parameters of each reference picture in the reference picture list. For example, if there are multiple reference pictures in a reference picture list of an enhancement layer that have the same POC value Ref2POCBase[LX][refIdxBase], the reference picture that has the same or closest weight(s) (e.g. luma weight) for weighted prediction compared to that/those of the reference picture in the base layer with reference index refIdxBase.
   If the aforementioned process cannot find a mapping satisfying the above criteria, the corresponding entry in the refMapTable can be set to 0 in some embodiments or NA (standing for “not available”) in other embodiments.

In some embodiments, the derivation of the refMapTable can be performed so that for each reference picture list LX and for each possible refIdxBase value, the reference picture list of the enhancement layer is searched and the refIdxEnh is picked where |Ref2POCBase[LX][refIdxBase]-Ref2POCEnh[LX] [refIdxEnh]| (absolute difference) is minimum. Then, refMapTalbe[LX][refIdxBase]=refIdxEnh with minimum absolute difference.

If the minimum above absolute difference values result from multiple refIdxEnh values, extra processing can be performed. One possibility is that the weight of the reference picture refIdxEnh can be taken into account. This can be accomplished by choosing the enhancement layer reference picture whose weight is closest to the weight of the base layer reference picture at refIdxBase. If the weight based method also results multiple refIdxEnh candidates, then the smallest or largest refIdxEnh can be chosen. Another possibility is that the smallest or largest refIdxEnh can be directly chosen.

In an embodiment the refMapTable is block based instead of being slice based.

In an embodiment there can be additional signalling indicating whether the mapping process is used, or the reference index in enhancement layer for base layer prediction motion is always set to a pre-defined value.

In an embodiment, instead of a mapping table, the idea can be implemented using some pre-determined rules. Examples for the rules are:
if the corresponding POC values of the reference picture in the enhancement layer and of the reference picture in the base layer at index refIdxBase are identical then refIdxEnh=refIdxBase. Otherwise refIdxEnh=0.
if the corresponding POC value of reference pictures in enhancement layer and base layer at index refIdxBase are identical then refIdxEnh=refIdxBase. Otherwise refIdxEnh=reference index where corresponding POC values of reference pictures in enhancement layer and base layer differ by minimum.

In an embodiment, instead of a mapping table, a similar mapping process can be used to derive the mapping whenever needed.

In an embodiment, an initial reference picture list in an enhancement layer is inherited from its reference layer. As part of or in connection with this inheritance, such pictures that exist in the reference picture list of the reference layer but for which corresponding pictures (e.g. with the same POC value) are not marked as used for reference in the enhancement layer are not included or are removed from the initial reference picture list of the enhancement layer.

The encoder may modify the initial reference picture list to the final reference picture list and encode respective indications of the preformed modifications into the bitstream. Alternatively, the encoder may indicate that no modification to the initial reference picture list is done and it therefore forms the final reference picture list. The decoder decodes the indications from the bitstream and performs the derivation of the final reference pictures lists accordingly and hence has the same final reference picture lists as the encoder has. The mapping table may be created according to the above described process of deriving the enhancement layer reference picture list. For example, if a picture with index RIB in the reference picture list of the reference layer does not have a corresponding picture (e.g. with the same POC value) marked as used for reference in the enhancement layer, the mapping table or process may be modified to return refIdxEnh=refIdxBase+1, when refIdxBase>RIB. Similarly, a reference picture list modification or reordering may be reflected in the mapping table or process.

Instead of or in addition to POC, other means for identifying picture order value can be used in the embodiments described above, including but not limited to the following:
pic_order_cnt_lsb or similar syntax element that conveys a selected number of least significant bits of a POC value
a syntax element or a variable derived in the encoding/decoding process that is indicative of decoding order of access units or pictures within a layer, which may be accompanied by an identification of the previous RAP (random access point) picture and/or a layer identifier and/or a temporal sub-layer identifier
an index within an indicate structure of pictures

In various embodiments, there may be more than one block in the base/reference layer from which the motion information is derived to a single block (e.g. a prediction unit) in an enhancement layer. Such situations may happen, for example, when spatial scalability is in use and/or when the enhancement layer uses block partitioning different from that of base/reference layer. The blocks of the base/reference layer can be referred as “co-located BL blocks” in the following. In such a case, the base/reference layer reference index used as an input to the mapping table/process may be selected in various ways including but not limited to the following or a combination of:
a minimum non-negative reference index of the co-located BL blocks may be used
a largest one (in sample count) of the co-located BL blocks having a non-negative reference index may be used. The sample count may be constrained to contain only samples co-located with the EL block and exclude samples that do not co-locate with the EL block even if they belonged to the same BL block (e.g. PU).
any of the above means further constrained by the fact that a picture with the same POC (and potentially with same weighted prediction parameters) is available in the reference pictures list of the enhancement layer.

In some embodiments, a list of candidate motion vectors (and their reference indexes), e.g. to be used in AMVP or merge mode, is created and includes a motion vector derived from the base layer as described in various embodiments above. However, in some embodiments, if no correspondence of reference indexes and potentially prediction weights was found, e.g. refMapTable[LX][refIdxBase] is equal to NA in the first embodiment, the candidate motion vector derived from the base layer may be excluded from the list of candidate motion vectors. In some embodiments, the candidate motion vector derived from base layer can be excluded if either of refMapTable[L0][refIdxBase] or refMapTable[L1] [refIdxBase] is equal to NA. Similarly in some embodiments, the candidate motion vector derived from base layer can be excluded if both of refMapTable[L0][refIdxBase] or refMapTable[L1] [refIdxBase] are equal to NA.

The various embodiments improve the coding efficiency of scalable video coders when base layer uses a different prediction structure than the enhancement layer.

In the above, some embodiments have been described with reference to an enhancement layer and a base layer. It needs to be understood that the base layer may as well be any other layer as long as it is a reference layer for the enhancement layer. It also needs to be understood that the encoder may generate more than two layers into a bitstream and the decoder may decode more than two layers from the bitstream. Embodiments could be realized with any pair of an enhancement layer and its reference layer. Likewise, many embodiments could be realized with consideration of more than two layers.

Embodiments of the present invention may be implemented in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIGS. 7 and 8. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method, comprising:
obtaining motion information of an enhancement layer of a picture using motion vector information of a reference layer, wherein the obtaining comprises
deriving a reference index of a motion vector of the enhancement layer by using a mapping process depending on the used reference picture list of the reference layer and the used reference picture list of the enhancement layer and a reference index of a motion vector of the reference layer.

2. The method according to claim 1, wherein the obtaining further comprises
deriving a candidate list of motion vectors and their reference indexes,
selecting a motion vector and a reference index from said candidate list.

3. The method according to claim 1, wherein the mapping process comprises utilization of a mapping table, the method further comprising
deriving values for the mapping table using corresponding picture order values of the reference pictures of the enhancement reference picture and the reference layer reference pictures.

4. The method according to claim 3, further comprising
searching the reference picture list for the enhancement layer and the reference layer,
deriving the mapping table values by mapping the picture order value of reference pictures in the reference layer reference picture list with the same picture order values of reference pictures in the enhancement layer reference picture list.

5. The method according to claim 3, further comprising
searching a reference picture list of the enhancement layer for each reference index of a reference picture list of the reference layer,
entering to the mapping table such a reference index of the enhancement layer by which the absolute difference of picture order values between the reference layer and the enhancement layer is minimum.

6. The method according to claim 1, wherein the reference layer is a base layer or base view.

7. The method according to claim 1, wherein the mapping process further comprising
comparing for each reference index, the picture order value of reference pictures in enhancement layer with picture order value of reference pictures in reference layer
as response to picture order values of reference pictures in enhancement layer being equal to picture order values of reference pictures in reference layer for all reference indices, using the reference index of a motion vector of the reference layer for reference index of motion vector in enhancement layer
as response to picture order values of reference pictures in enhancement layer not being equal to picture order values of reference pictures in reference layer for all reference indices, setting the reference index of motion vector in enhancement layer to zero.

8. The method according to claim 1, comprising encoding an uncompressed picture into a coded picture using the motion information of the enhancement layer.

9. The method according to claim 1, comprising decoding a coded picture into a decoded picture using the motion information of the enhancement layer.

10. An apparatus comprising at least one processor, memory including computer program code, the memory and the computer program code configured to, with the at least one processor, cause the apparatus to perform at least the following:
obtaining motion information of an enhancement layer of a picture using motion vector information of a reference layer, wherein the obtaining comprises
deriving the reference index of motion vector of the enhancement layer by using a mapping process depending on the used reference picture list of the reference layer and the user reference picture list of the enhancement layer and the reference index of a motion vector of the reference layer.

11. The apparatus according to claim 10, further comprising computer program code configured to, with the processor, cause the apparatus to perform at least the following:
deriving a candidate list of motion vectors and their reference indexes,
selecting a motion vector and a reference index from said candidate list.

12. The apparatus according to claim 10, wherein the mapping process comprises utilization of a mapping table, the apparatus further comprising computer program code configured to, with the processor, cause the apparatus to perform at least the following:
deriving values for the mapping table using corresponding picture order values of the reference pictures of the enhancement reference picture and the reference layer reference pictures.

13. The apparatus according to claim 12, further comprising computer program code configured to, with the processor, cause the apparatus to perform at least the following:
searching the reference picture list for the enhancement layer and the reference layer,
deriving the mapping table values by mapping the picture order value of reference pictures in the reference layer reference picture list with the same picture order value of reference pictures in the enhancement layer reference picture list.

14. The apparatus according to claim 12, further comprising computer program code configured to, with the processor, cause the apparatus to perform at least the following:
deriving values for the mapping table by
searching a reference picture list of the enhancement layer for each reference index of a reference picture list of the reference layer,
entering to the mapping table such a reference index of the enhancement layer by which the absolute difference of picture order values between the reference layer and the enhancement layer is minimum.

15. The apparatus according to claim 10, wherein the reference layer is a base layer or base view.

16. The apparatus according to claim 10, said at least one memory stored with program code thereon, which when executed by said at least one processor, further causes the apparatus to decode a coded picture into a decoded picture using the motion information of the enhancement layer.

17. The apparatus according to claim 10, said at least one memory stored with program code thereon, which when executed by said at least one processor, further causes the apparatus to decode a coded picture into a decoded picture using the motion information of the enhancement layer.

18. A computer program product embodied on a non-transitory computer readable medium, comprising computer program code configured to, when executed on at least one processor, cause an apparatus or a system to:
obtain motion information of an enhancement layer using motion vector information of a reference layer, wherein the obtaining comprises
deriving a reference index of a motion vector of the enhancement layer by using a mapping process depending on the used reference picture list of the reference layer and the used reference picture list of the enhancement layer and a reference index of a motion vector of the reference layer.

19. The computer program product according to claim 18, further comprising computer program code configured to, when executed on at least one processor, cause an apparatus or a system to:
encode an uncompressed picture into a coded picture using the motion information of the enhancement layer.

20. The a computer program product according to claim 18, further comprising computer program code configured to, when executed on at least one processor, cause an apparatus or a system to:
decode a coded picture into a decoded picture using the motion information of the enhancement layer.
